(19) United States
(12) Patent Application Publication
(10) Pub. No.: US 2023/0201846 A1
(43) Pub. Date: Jun. 29, 2023

(54) INFLATABLE SPRAYHEAD

(71) Applicant: Purity (Xiamen) Sanitary Ware Co., Ltd., Xiamen City (CN)

(72) Inventors: JAMES WU, Taichung City (TW); ALEX WU, Taichung City (TW); CE-WEN YANG, Xiamen City (CN)

(73) Assignee: Purity (Xiamen) Sanitary Ware Co., Ltd., Xiamen City (CN)

(21) Appl. No.: 17/824,581

(22) Filed: May 25, 2022

(30) Foreign Application Priority Data
Dec. 29, 2021 (CN) 202111640935.2

(51) Int. Cl. B05B 1/18; B05B 15/74

(52) U.S. Cl. CPC B05B 1/185; B05B 15/74

(57) ABSTRACT

An inflatable sprayhead includes a main body made of an elastic material. The main body includes an inflatable portion and an output portion. The inflatable portion and the output portion are coupled. The inflatable portion has a first chamber inside, and the inflatable portion is changeable between an inflated state and an uninflated state by inflating or deflating the first chamber. The output portion has a second chamber and an output surface, which communicates with the second chamber. The main body includes an isolation portion that is located between the inflatable portion and the output portion, wherein the first chamber and the second chamber are separated by the isolation portion. Thus, when the main body is in the uninflated state, a volume of the main body could be reduced. Additionally, the main body that is foldable and flexible facilitates storage.

### BACKGROUND OF THE INVENTION

### Technical Field

The present invention relates generally to a sprayhead, and more particularly to a inflatable sprayhead.

### Description of Related Art

Either a conventional shower device or a conventional plant watering device usually includes a conventional sprayhead for spraying the liquid. Generally, the sprayhead is usually made of a hard material and has a regular size and a specific shape, so that the sprayhead is unable to be arbitrarily deformed. Thus, the conventional sprayhead is not easy to store after use or carry after buy.

### BRIEF SUMMARY OF THE INVENTION

In view of the above, the primary objective of the present invention is to provide an inflatable sprayhead that is made of a flexible material, so that the sprayhead could be deformed or folded to reduce a volume of the sprayhead, thereby enhancing the convenience of storage.

The present invention provides an inflatable sprayhead including a main body made of an elastic material. The main body includes an inflatable portion and an output portion, wherein the inflatable portion is coupled with the output portion. The inflatable portion has a first chamber inside. By inflating or deflating the inflatable portion, the main body is changed between an inflated state and an uninflated state. The output portion has a second chamber. The main body further comprises an isolation portion, wherein the isolation portion is disposed between the inflatable portion and the output portion, and the first chamber and the second chamber are separated by the isolation portion.

Since the main body is made of the elastic material, when the main body is turned into the uninflated state from the inflated state, the inflatable portion of the main body turns flat to reduce a volume of the main body. The material of the main body is flexible and foldable, so that the inflatable sprayhead could be folded to save storing space, which is easy for storing and carrying.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the inflatable sprayhead of a first embodiment according to the present invention;

FIG. 2 is a perspective view of the inflatable sprayhead of the first embodiment seen from another perspective;

FIG. 3 is an exploded view of the inflatable sprayhead of the first embodiment according to the present invention;

FIG. 4 is a top view of the inflatable sprayhead of the first embodiment according to the present invention;

FIG. 5 is a sectional view taken along the 5-5 line in FIG. 4;

FIG. 6 is an enlarged partial view of a marked region 6 in FIG. 5;

FIG. 7 is a side view of the inflatable sprayhead of the first embodiment in the uninflated state;

FIG. 8 is a perspective view of the inflatable sprayhead of the first embodiment in a folded position;

FIG. 9 is a side view of the inflatable sprayhead of the first embodiment in a folded position;

FIG. 10 is a side view of the inflatable sprayhead of a second embodiment according to the present invention;

FIG. 11 is a side view of the inflatable sprayhead of the second embodiment in the uninflated state;

FIG. 12 is a perspective view of the inflatable sprayhead of the second embodiment in the folded position; and

FIG. 13 is a side view of the inflatable sprayhead of the second embodiment in the folded position.

### DETAILED DESCRIPTION OF THE INVENTION

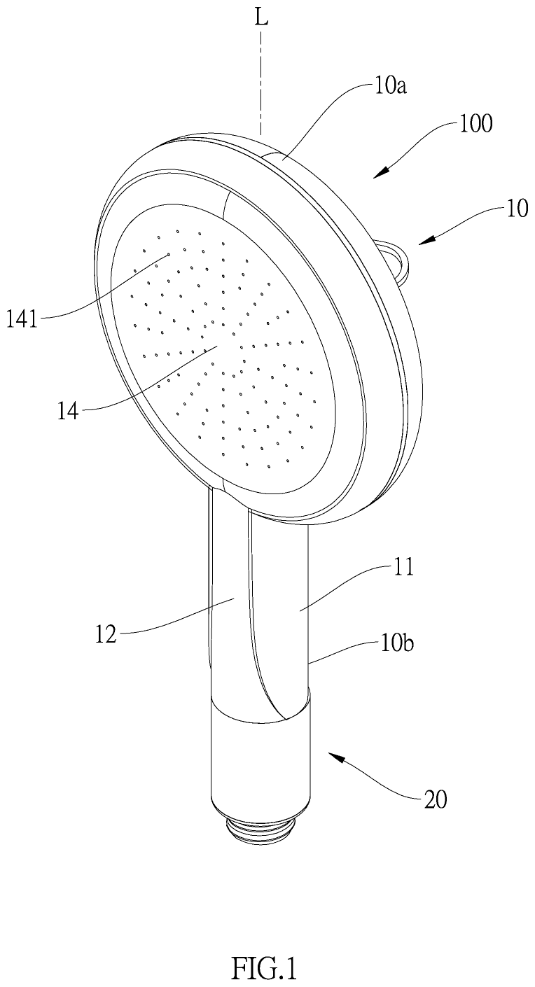

As illustrated in FIG. 1, an inflatable sprayhead 100 of a first embodiment according to the present invention includes a main body 10, a joint fitting 20, and a strap 30.

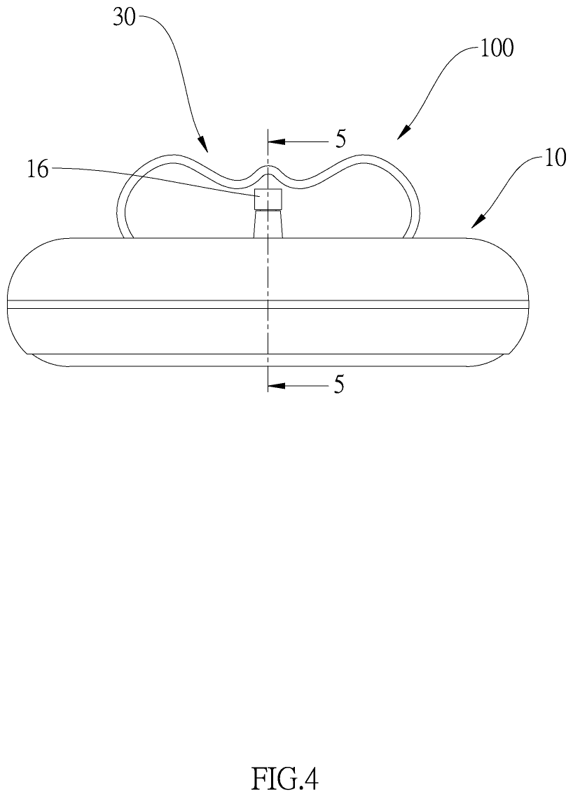

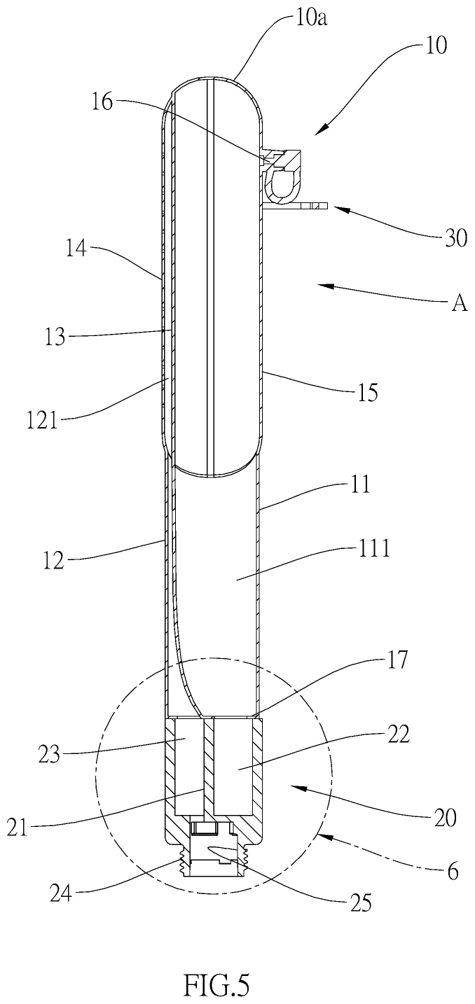

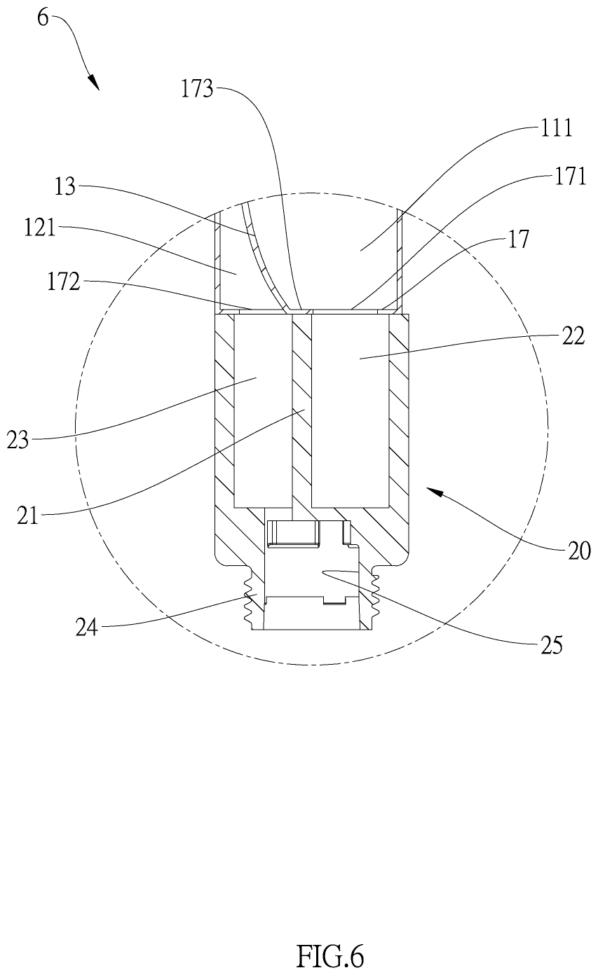

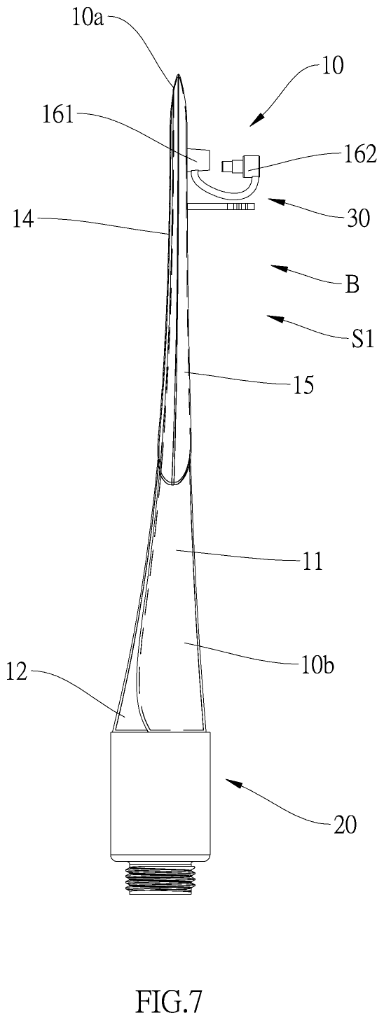

As illustrated in FIG. 1 to FIG. 7, the main body 10 is made of an elastic material and includes an inflatable portion 11 and an output portion 12, wherein the inflatable portion 11 is coupled with the output portion 12. The inflatable portion 11 has a first chamber 111 inside, and the inflatable portion 11 could be inflated or deflated to change the main body 10 between an inflated state A and an uninflated state B. When the inflatable portion 11 is inflated, the main body 10 is driven to change into the inflated state A, the inflatable portion 11 provides support to the main body 10, as shown in FIG. 1. When the inflatable portion 11 is deflated, the main body 10 is driven to change from an inflated state A into the uninflated state B, as shown in FIG. 7. The output portion 12 has a second chamber 121 for transmitting a liquid. As illustrated in FIG. 4, the main body 10 further includes an isolation portion 13. The isolation portion 13 is disposed between the inflatable portion 11 and the output portion 12, so that the first chamber 111 and the second chamber 121 are separated by the isolation portion 13. In the first embodiment, when the main body 10 is in the inflated state A, the gas in the first chamber 111 is prevented by the isolation portion 13 from entering the second chamber 121. Besides, the inflatable portion 11 is inflated to push toward the output portion 12, so that a volume of the first chamber 111 is greater than a volume of the second chamber 121, thereby increasing an output pressure of the liquid flow through the second chamber 121.

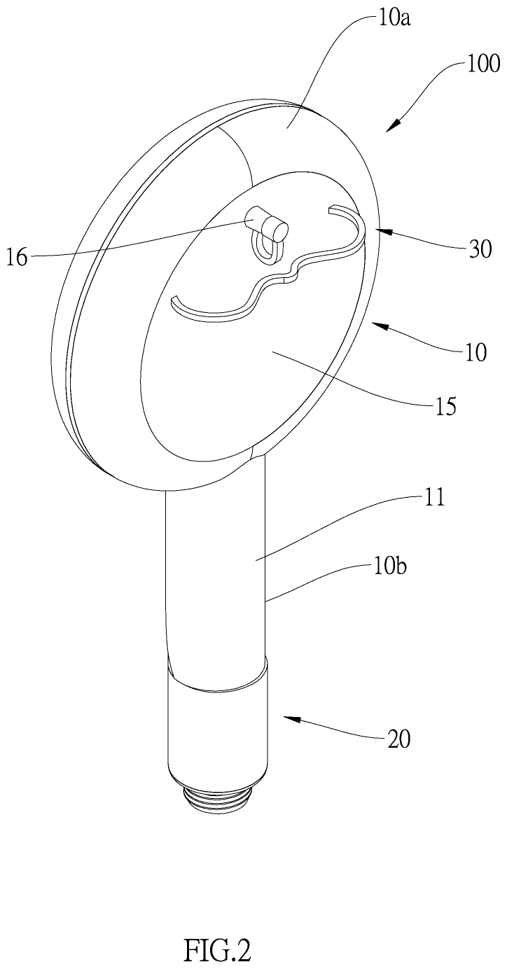

As illustrated in FIG. 1 to FIG. 4, in the first embodiment, the main body 10 includes a sprayhead section 10a and a holding section 10b. The sprayhead section 10a and the holding section 10b are constituted of the inflatable portion 11 and the output portion 12. An appearance of the sprayhead section 10a is circular, wherein a side of the sprayhead section 10a is disposed with an output surface 14, and another side of the sprayhead section 10a has a mounting surface 15. As illustrated in FIG. 2, the mounting surface 15 is located at the inflatable portion 11, and a nozzle 16 is disposed on the mounting surface 15. The nozzle 16 includes a tube 161 and a sealing plug 162. The tube 161 communicates with the first chamber 111, and the sealing plug 162 is operatable to seal the tube 161. A user could directly inflate or deflate the inflatable portion 11 via the nozzle 16. As illustrated in FIG. 1, the output surface 14 is located at the output portion 11 and has a plurality of output perforations 141 that communicates the second chamber 121. The holding section 10b is connected to the sprayhead section 10a. When the main body 10 is in the inflated state A, the holding section 10b could be held by a hand of the user. In the embodiment, the main body 10 is defined to have an axis L that passes through the sprayhead section 10a, and the holding section 10b extends along the axis L from the sprayhead section 10a.

Since the main body 10 is made of the elastic material. When the main body 10 is turned into the uninflated state B from the inflated state A, the inflatable portion 11 of the main body 10 is deflated to become flat, and a volume of the main body 10 is significantly reduced. The material of the main body 10 is elastic and flexible, so that the main body 10 could be easily stored by folding or rolling.

In other embodiment, a structure of the main body 10 could be modified on a required demand. For example, the appearance of the sprayhead section 10a of the main body 10 could be in another shape. The holding section 10b of the main body 10 could be omitted. Alternatively, the holding section 10b could be substituted with a handle of a general sprayhead, as long as that could be held by the user.

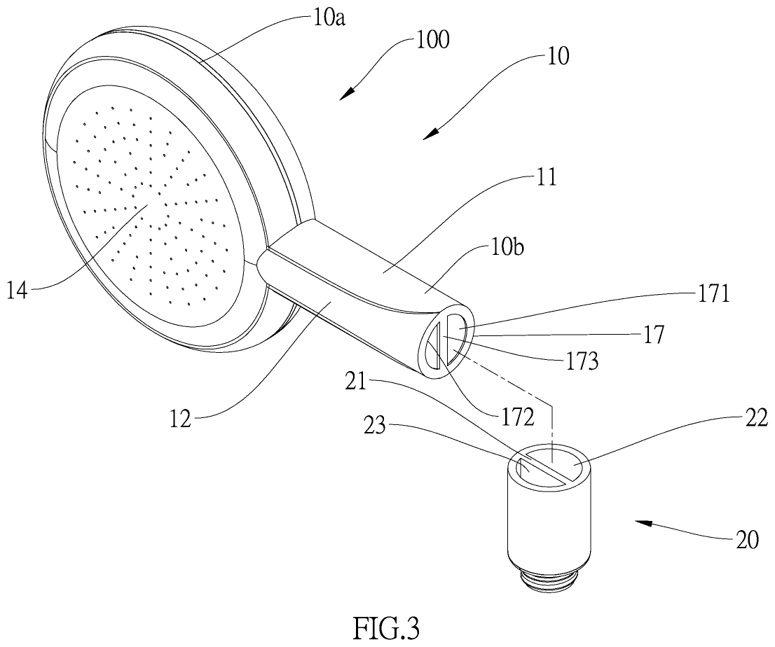

As illustrated in FIG. 3, the main body 10 has a separating portion 17. The separating portion 17 is located at an end of the holding section 10b and is connected to the inflatable portion 11 and the output portion 12. The separating portion 17 has a first opening 171 and a second opening 172. The first opening 171 communicates with the first chamber 111, and the second opening 172 communicates with the second chamber 121. The separating portion 17 has a separating plate 173 for separating the first opening 171 and the second opening 172, wherein the isolation portion 13 extends from the sprayhead section 10a to the holding section 10b and is connected to the separating plate 173.

The joint fitting 20 is engaged with the separating portion 17 of the main body 10 and is used for connecting to a hose (not shown). As illustrated in FIG. 3 to FIG. 5, the joint fitting 20 has a blocking portion 21 is correspondingly engaged with the separating plate 173 of the separating portion 17. The joint fitting 20 has an air groove 22 and a channel 23 for water flow. The air groove 22 and the channel 23 for water flow are located at two sides of the blocking portion 21, respectively. The air groove 22 communicates the first opening 171 of the separating portion 17 and the first chamber 111 of the inflatable portion 11. The channel 23 for water flow communicates with the second opening 172 of the separating portion 17 and the second chamber 121 of the output portion 12. An end of the joint fitting 20 has a screw portion 24 and an inlet 25. The screw portion 24 is adapted to connect to the hose. The inlet 25 passes through the screw portion 18 and communicates with the second chamber 121 for allowing liquid that flows through the hose to flow into the second chamber 121.

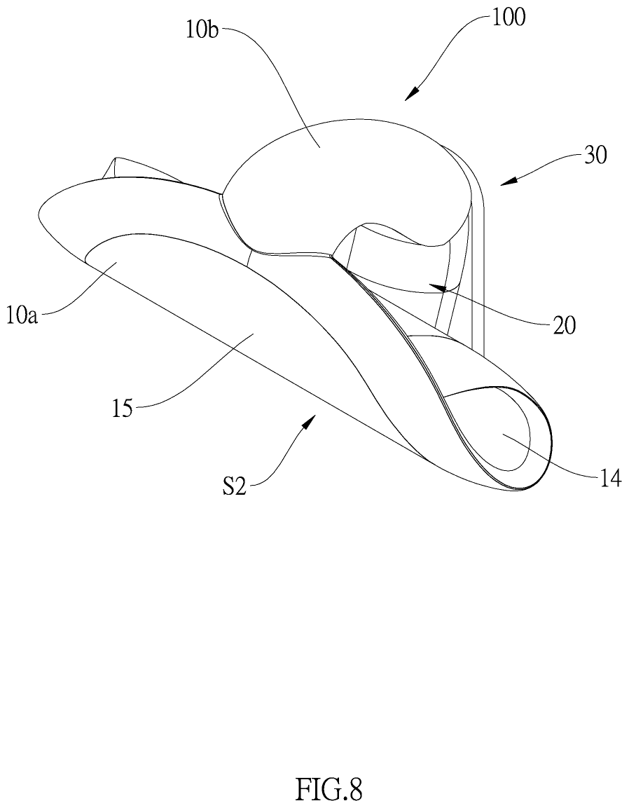

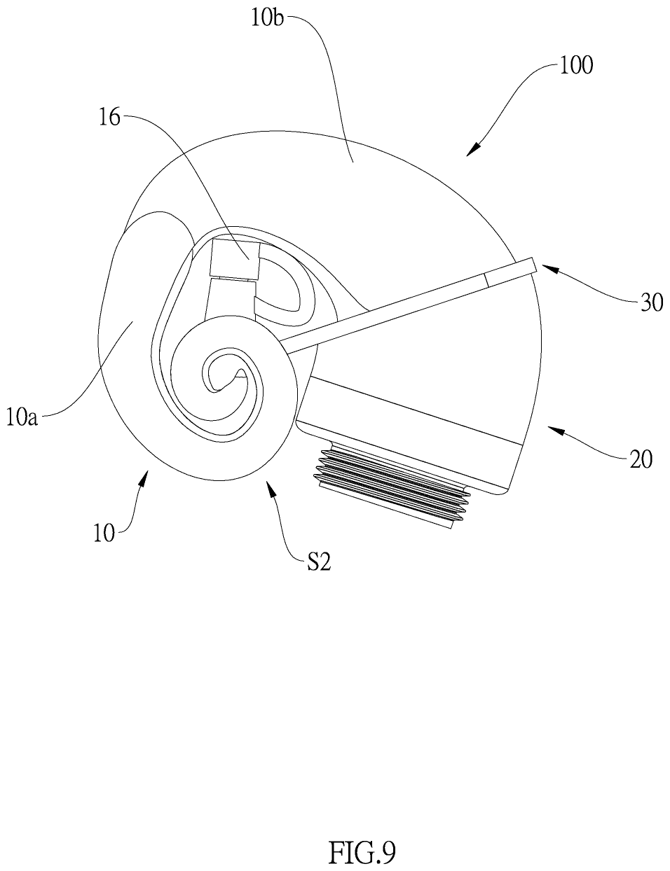

The strap 30 is disposed on the main body 10. As illustrated in FIG. 2 and FIG. 3, in the first embodiment, the strap 30 is located at the mounting surface 15 of the inflatable portion 11, and two ends of the strap 30 are connected to the mounting surface 15 to form a ring. When the main body 10 is in the uninflated state B, the main body 10 is changeable between an extended position S1 and a folded position S2. As illustrated in FIG. 7, when the main body 10 is deflated to turn from the inflated state A to the uninflated state B, the main body 10 is located in an extended position S1. As illustrated in FIG. 8 and FIG. 9, when the main body 10 is folded from the sprayhead section 10a toward the holding section 10b to wind the output surface 14 inside, and the strap 30 is utilized to fit around the holding section 10b and the joint fitting 20, the main body 10 is turned into a folded position S2. Therefore, after the inflatable sprayhead 100 is used, the main body 10 could be inflated to form the uninflated state B, and then rolled from the extended position S1 to the folded position S2 to significantly reduce a volume of the main body 10. Thus, the inflatable sprayhead 100 could be easily stored and carried on.

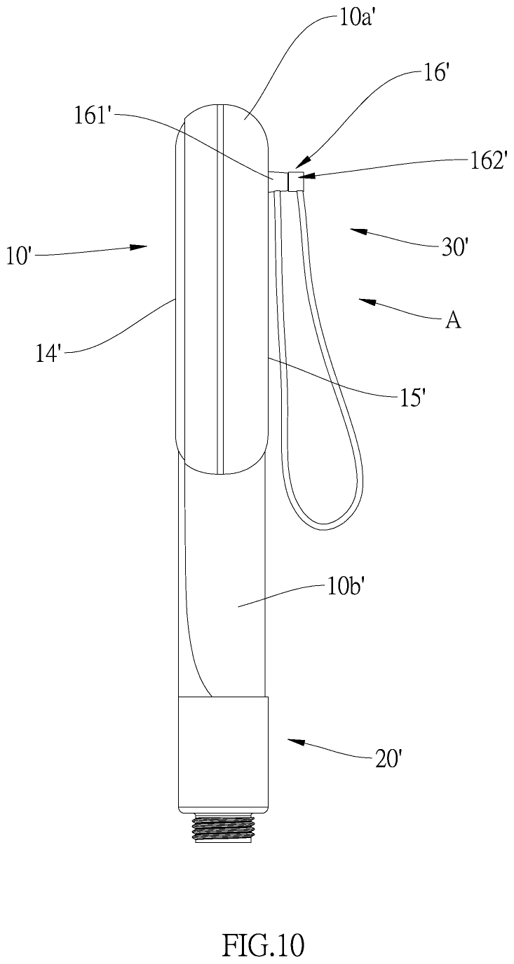

As illustrated in FIG. 10 to FIG. 13, an inflatable sprayhead 100′ of a second embodiment according to the present invention includes a main body 10′, a joint fitting 20′, and a strap 30′, wherein inflatable sprayhead 100′ of the second embodiment has almost the same structure as that of the first embodiment, except that a location of the strap 30′.

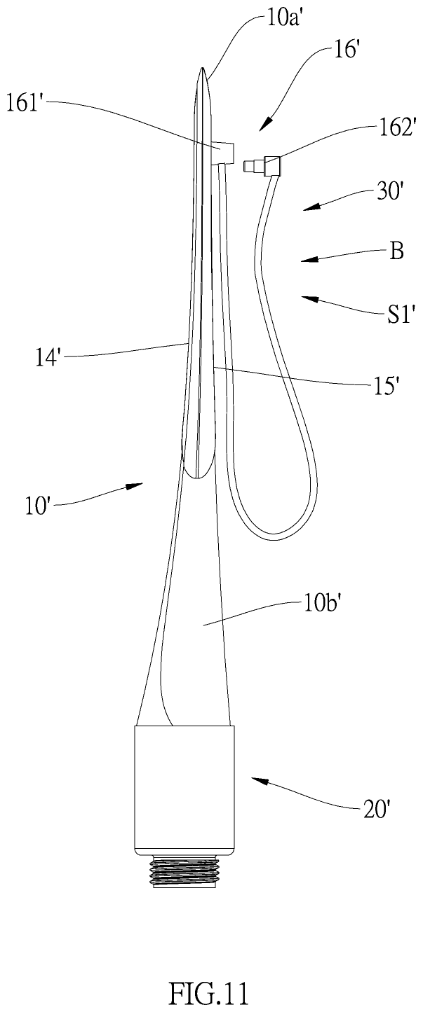

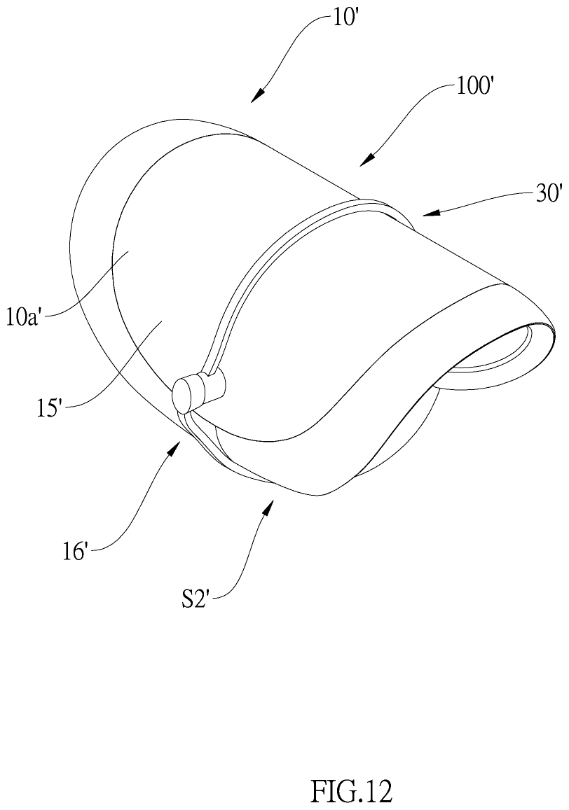

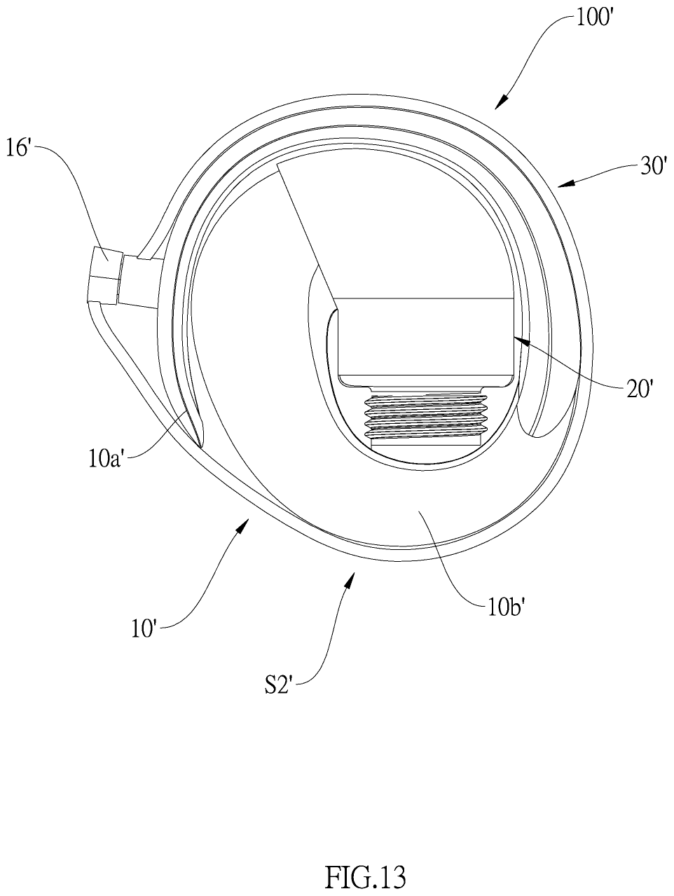

As illustrated in FIG. 10, the strap 30′ is disposed on a nozzle 16′ of the main body 10′, wherein two ends of the strap 30′ are connected to the tube 161′ and the sealing plug 162′ of the nozzle 16′, respectively. When the main body 10′ is in the uninflated state B, the main body 10′ is changeable between an extended position S1′ and a folded position S2′. As illustrated in FIG. 11, when the main body 10 is deflated to turn from the inflated state A to the uninflated state B, the main body 10′ is in an extended position S1′, and the tube 161′ and the sealing plug 162′ of the nozzle 16′ are disengaged from each other. As illustrated in FIG. 12 and FIG. 13, the main body 10′ is rolled from the joint fitting 20′ toward the sprayhead section 10a′ to wind the output surface 14′ inside, thereby allowing the nozzle 16′ disposed on the mounting surface 15′ is exposed outside. At the time, the sealing plug 162′ is drawn around the inflatable sprayhead 100′ that is rolled to enclose the sprayhead section 10a′ and the holding section 10b′ by the strap 30′, and the sealing plug 162′ is connected to the tube 161′, the main body 10′ is turned into a folded position S2′. When the main body 10′ is in the folded position S2′, a volume of the main body 10 is reduced, thereby enhancing the convenience of storing the inflatable sprayhead 100′.

With such design, since the main body 10 is made of the elastic material, when the main body 10 is turned from the inflated state A into the uninflated state B, the volume of the main body 10 could be reduced. Since the material of the main body 10 is flexible and foldable, the inflatable sprayhead 100 could be conveniently stored.

Additionally, after the inflatable sprayhead 100 is used, the main body 10 could be inflated to form the uninflated state B and folded from the extended position S1 to the folded position S2. Since the inflatable sprayhead 100 could be folded or rolled to reduce a storage space that is demanded for storing the inflatable sprayhead 100, the inflatable sprayhead 100 is easy for storing or carrying.

It must be pointed out that the embodiment described above is only a preferred embodiment of the present invention. All equivalent structures which employ the concepts disclosed in this specification and the appended claims should fall within the scope of the present invention.

What is claimed is:

1. An inflatable sprayhead, comprising:
a main body made of an elastic material and comprising an inflatable portion and an output portion, wherein the inflatable portion is coupled with the output portion; the inflatable portion has a first chamber inside; by inflating or deflating the inflatable portion, the main body is changed between an inflated state and an uninflated state; the output portion has a second chamber; the main body further comprises an isolation portion, wherein the isolation portion is disposed between the inflatable portion and the output portion, and the first chamber and the second chamber are separated by the isolation portion.

2. The inflatable sprayhead as claimed in claim 1, wherein the main body has a sprayhead section that is constituted of the inflatable portion and the output portion; a side of the sprayhead section is disposed with an output surface, and another side of the sprayhead section has a mounting surface; the mounting surface is located at the inflatable portion; a nozzle is disposed on the mounting surface and communicates with the first chamber; the output surface is located at the output portion and has a plurality of output perforations that communicate the second chamber.

3. The inflatable sprayhead as claimed in claim 2, wherein the main body comprises a holding section that extends outward from the sprayhead section.

4. The inflatable sprayhead as claimed in claim 3, comprising a strap, wherein the strap is disposed on the inflatable portion; when the main body is in the uninflated state, the main body is changeable between an extended position and a folded position; when the main body is deflated to turn from the inflated state to the uninflated state, the main body is located in an extended position; when the main body is folded from the sprayhead section toward the holding section to wind the output surface in side, and the strap is utilized to fit around the holding section, the main body is turned into the folded position.

5. The inflatable sprayhead as claimed in claim 3, comprising a strap, wherein the strap is disposed on the nozzle; the nozzle has a tube and a sealing plug, wherein the sealing plug is operatable to seal the tube; two ends of the strap are connected to the tube and the sealing plug, respectively.

6. The inflatable sprayhead as claimed in claim 5, wherein when the main body is deflated to turn from the inflated state to the uninflated state, the main body is located in an extended position, and the tube and the sealing plug of the nozzle are disengaged from each other; after the main body is rolled from the holding section toward the sprayhead section to wind the output surface inside, the strap is driven by the sealing plug to enclose the sprayhead section and the holding section, and the sealing plug is engaged with the tube, thereby turning the main body into a folded position.

7. The inflatable sprayhead as claimed in claim 1, wherein the main body has a separating portion; the separating portion is connected to the inflatable portion and the output portion; the separating portion has a first opening and a second opening, wherein the first opening communicates with the first chamber, and the second opening communicates with the second chamber; the separating portion has a separating plate for separating the first opening and the second opening; the separating plate is connected to the isolation portion.

8. The inflatable sprayhead as claimed in claim 7, comprising a joint fitting that is engaged with the separating portion of the main body and is used for connecting to a hose, wherein the joint fitting has a blocking portion that is correspondingly engaged with the separating plate of the separating portion; the joint fitting has an air groove and a channel for water flow, wherein the air groove communicates the first opening of the separating portion, and the channel for water flow communicates with the second opening of the separating portion; the air groove and the channel for water flow are located at two sides of the blocking portion, respectively.

9. The inflatable sprayhead as claimed in claim 8, wherein an end of the joint fitting has a screw portion and an inlet passing through the screw portion, the screw portion is adapted to connect to the hose; the inlet communicates with the second chamber for allowing liquid flow through the hose to flow into the second chamber.
